(19) United States
(12) Patent Application Publication
(10) Pub. No.: US 2016/0305308 A1
(43) Pub. Date: Oct. 20, 2016

(54) VARIABLE PUMP FOR AN INTERNAL COMBUSTION ENGINE

(71) Applicant: PIERBURG GMBH, Neuss (DE)

(72) Inventors: MARTIN NOWAK, LEVERKUSEN (DE); ALBERT GENSTER, MARL (DE); STEFAN ROTHGANG, RHEINBERG (DE); MICHAEL-THOMAS BENRA, CASTROP-RAUXEL (DE)

(73) Assignee: PIERBURG GMBH, Neuss (DE)

(21) Appl. No.: 15/100,640

(22) PCT Filed: Nov. 20, 2014
(86) PCT No.: PCT/EP2014/075071

§ 371 Date: Jun. 1, 2016

(30) Foreign Application Priority Data
Dec. 3, 2013 (DE) 10 2013 113 362.2

(51) Int. Cl. F01P 5/10; F16D 33/04; F16D 1/06; F04D 13/02; F04D 29/22

(52) U.S. Cl. CPC F01P 5/10; F04D 13/021; F04D 29/2261; F16D 1/06; F16D 33/04

(57) ABSTRACT

A variable pump for an internal combustion engine incudes a drive wheel, a drive shaft configured to be driven via the drive wheel, a coupling pump impeller comprising pump blades, a coupling turbine wheel comprising turbine blades arranged axially opposite to the pump blades, and an impeller which is fixedly connected with the coupling turbine wheel. The coupling pump impeller is arranged to be rotationally fixed on the drive shaft. The coupling turbine wheel is configured to rotate on the drive shaft. The coupling pump impeller is arranged so as to be axially displaceable with respect to the coupling turbine wheel.

### CROSS REFERENCE TO PRIOR APPLICATIONS

This application is a U.S. National Phase application under 35 U.S.C. §371 of International Application No. PCT/EP2014/075071, filed on Nov. 20, 2014 and which claims benefit to German Patent Application No. 10 2013 113 362.2, filed on Dec. 3, 2013. The International Application was published in German on Jun. 11, 2015 as WO 2015/082223 A1 under PCT Article 21(2).

### FIELD

The present invention relates to a variable pump for an internal combustion engine having a drive wheel, a drive shaft adapted to be driven via the drive shaft, a coupling pump impeller with pump blades arranged at the drive shaft in a rotationally fixed manner, a coupling turbine wheel with turbine blades rotatably supported on the drive shaft, the turbine blades being arranged axially opposite to the pump impellers, and an impeller which is fixedly connected with the coupling turbine wheel.

### BACKGROUND

In internal combustion engines, it is common practice that various pumps, such as coolant pumps, oil pumps, or vacuum pumps, are coupled with the crankshaft of the internal combustion engine via belt and chain drives so that no additional drive units are required. To adapt the required volume flow of these pumps to requirements, it is known that the throughput of these pumps can be controlled via control elements. To reduce energy consumption, couplings have been used via which the drive unit can be decoupled from the output unit so that feeding is not effected against an increased flow resistance. It is thus known to arrange hysteresis couplings, electromagnetic couplings, or hydrodynamic couplings between the feeding element of the pump and the drive wheel.

One of these hydrodynamic couplings is the hydrodynamic coupling which operates according to the Fottinger principle. The function of this coupling is based on the movement of the pump impeller being transferred, between a driven coupling pump impeller and an opposite coupling turbine wheel, to the coupling turbine wheel via the dynamics of the fluid arranged between the wheels. The less fluid which can flow out between the two wheels, the larger is the transfer of the torque from the coupling pump impeller to the coupling turbine wheel.

The use of such a coupling for a variable coolant pump is described in DE 101 42 263 C1. The coupling pump impeller of the Fottinger coupling is arranged at the drive shaft of the pump. The coupling pump impeller cooperates with a coupling turbine wheel arranged at the rear side of the impeller of the coolant pump. The impeller is rotatably supported on the drive shaft. The coupling pump impeller includes radially internal inflow openings for a fluid. A gap is also formed at the outer circumference between the coupling turbine wheel and the coupling pump impeller, through which gap the fluid can flow out. A movable slider is provided to control the pump, the movable slider being adapted to control the height of the outer circumferential gap. Closing this gap increases the torque transferred from the coupling pump impeller to the coupling turbine wheel. The adjustment is effected via a thermocouple or an external adjuster. The design of such a pump is relatively complicated since many parts must be installed and becasue manufacture and installation, in particular with regard to the slider and the coupling turbine wheel, must be carried out within narrow tolerance ranges.

### SUMMARY

An aspect of the present invention is to provide a variable pump for an internal combustion engine wherein, in contrast to conventional designs, component parts can be omitted so that the pump can be manufactured with larger tolerances. An additional aspect of the present invention is to provide a variable pump for an internal combustion engine where it is possible to provide an adequate feeding via the pump even if the actuator fails.

In an embodiment, the present invention provides a variable pump for an internal combustion engine incudes a drive wheel, a drive shaft configured to be driven via the drive wheel, a coupling pump impeller comprising pump blades, a coupling turbine wheel comprising turbine blades arranged axially opposite to the pump blades, and an impeller which is fixedly connected with the coupling turbine wheel. The coupling pump impeller is arranged to be rotationally fixed on the drive shaft. The coupling turbine wheel is configured to rotate on the drive shaft. The coupling pump impeller is arranged so as to be axially displaceable with respect to the coupling turbine wheel.

### BRIEF DESCRIPTION OF THE DRAWINGS

The present invention is described in greater detail below on the basis of embodiments and of the drawings in which:

FIG. 1 shows a cross-sectional side view of a pump according to the present invention where a minimal throughput is shown;

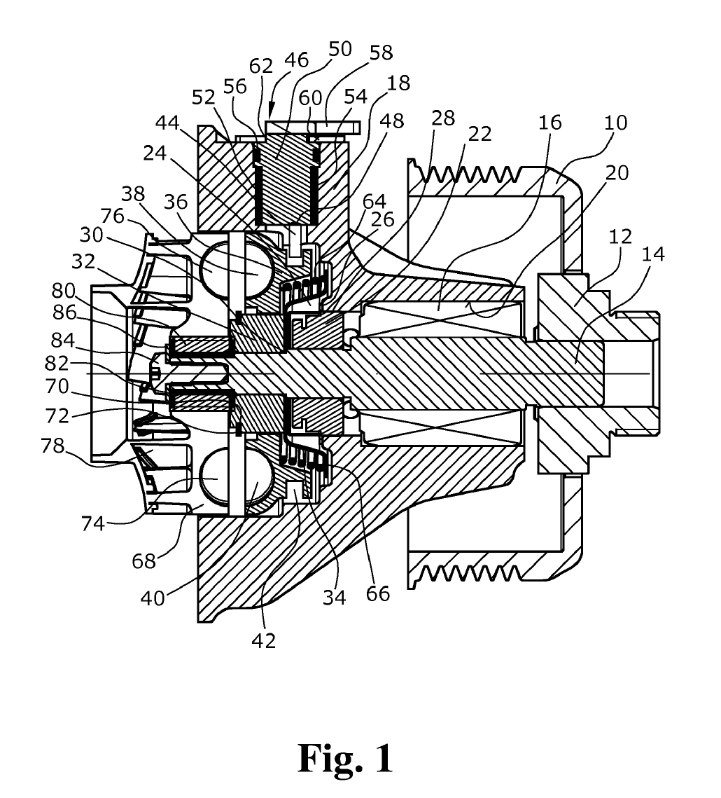

FIG. 2 shows a perspective view of the pump according to the present invention of FIG. 1 illustrating a partially cut-open housing and a minimum throughput; and

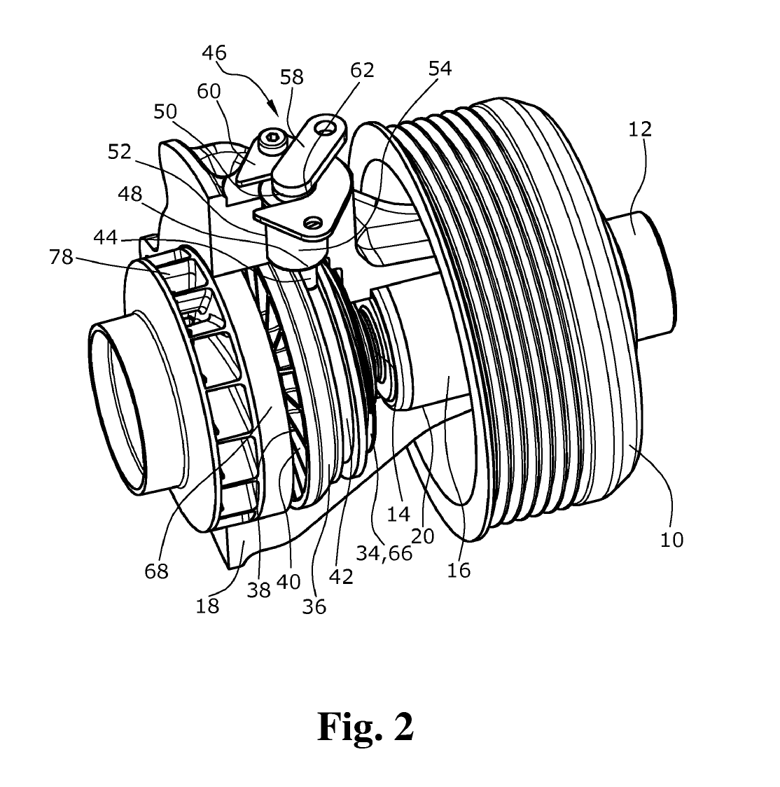

FIG. 3 shows a perspective view of the coupling pump impeller.

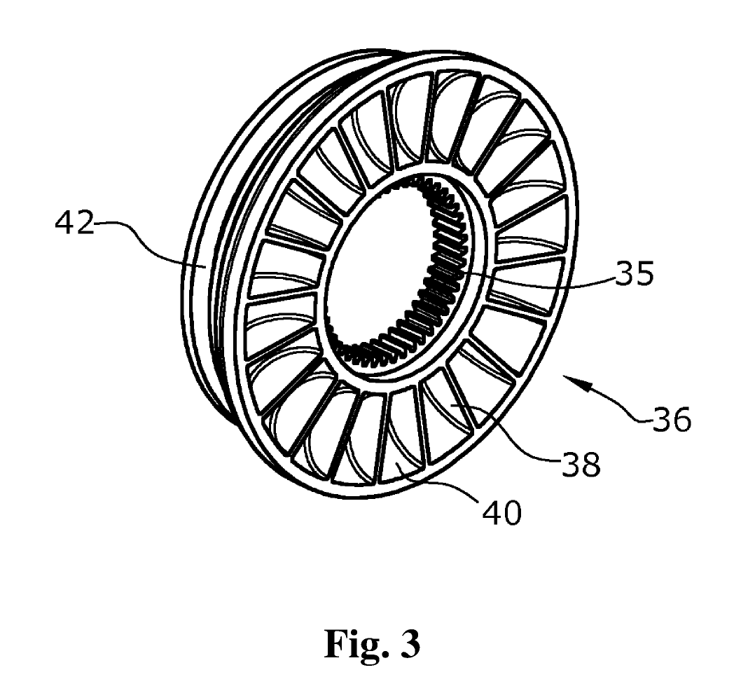

### DETAILED DESCRIPTION

A separate adjustment ring is not required since the coupling pump impeller is arranged in an axially displaceable manner relative to the coupling turbine wheel. Fewer component parts are thus necessary. Merely the position of the coupling turbine wheel relative to the coupling pump impeller must fit to provide a good torque transfer. Further tolerances, which are necessary when an adjustment ring is used, are not required.

In an embodiment of the present invention, the rotationally fixed connection between the coupling pump impeller and the drive shaft can, for example, be established by a form fit acting in the circumferential direction. Relocatability in the axial direction and a torque-transferring connection between the drive shaft and the coupling pump impeller are thus realized in a simple manner.

It can be advantageous when a follower is arranged at the drive shaft, which follower is connected with the drive shaft, and via which the form fit relative to the coupling pump impeller is established. Further mechanical treatment of the drive shaft is therefore not required. The manufacture is thereby facilitated.

In an embodiment of the present invention, the form fit acting in the circumferential direction can, for example, be established by two corresponding multi-tooth profiles, wherein one multi-tooth profile is defined at an outer circumference of the drive shaft or the follower, and one multi-tooth profile is arranged at an inner circumference of the coupling pump impeller. The use of a multi-tooth profile allows for the force for transferring the torque to be uniformly distributed over the circumference. The durability is thereby increased and unbalances are avoided.

In an embodiment of the present invention, a circumferential groove can, for example, be defined at the outer circumference of the coupling pump impeller, which groove engages with an actuator bolt adapted to be displaced in the axial direction. Operation of the actuator may thus allow for the coupling pump impeller to be axially displaced on the drive shaft in a simple manner.

In an embodiment of the present invention, the actuator can, for example, comprise a rotary shaft which serves as an eccentric at which the bolt is fastened eccentrically relative to the rotary shaft. Such a rotatable drive is easy to seal towards the outside. The adjustment can be effected via levers or directly.

A particularly simple design is achieved when the rotary shaft of the eccentric is supported in the housing of the pump, wherein a sealing ring is arranged between the rotary shaft and the housing. Additional housings or other additional component parts to be installed are thus not required. The support and the sealing can be installed from outside in a simple manner.

In an embodiment of the present invention, the coupling pump impeller can, for example, be loaded via a spring towards the coupling turbine wheel. Maximum feeding via the impeller is thereby provided in the case the actuator fails since the distance between the coupling pump impeller and the coupling turbine wheel for a maximum torque transfer is minimized.

The spring can, for example, be designed as a coil spring which rests upon the coupling pump impeller on the side axially opposite to the coupling turbine wheel. Such a spring is easy to install. The required spring force can be adjusted by using a correspondingly strong spring.

In order to provide a long service life of the coupling, the spring rests upon a supporting element at its axial end opposite to the coupling pump impeller, which supporting element is connected with the drive shaft in a rotationally fixed manner. A relative movement between the two bearing surfaces of the spring is thus avoided so that load application onto the spring in the circumferential direction is prevented.

A particularly simple installation of the supporting element is realized when, for establishing a rotationally fixed connection between the drive shaft and the supporting element, the supporting element is clamped between a shoulder of the drive shaft and the follower. Additional component parts for establishing the rotationally fixed connection are thus not required.

In an embodiment of the present invention, the drive shaft can, for example, be supported via a bearing unit which is sealed via a mechanical seal towards the pump space where the coupling pump impeller, the coupling turbine wheel, and the impeller are arranged. The pumping liquid is thereby prevented from entering the bearing unit of the drive shaft. Inexpensive grease-lubricated bearings can accordingly be used as shaft bearings.

In an embodiment of the present invention, a stopper can, for example, be defined at the outer circumference of the follower, via which stopper the axial movement of the coupling pump impeller towards the coupling turbine wheel is limited. An arrangement with tolerances between the actuator and the coupling turbine wheel is accordingly not required. The end position of the coupling pump impeller can be exclusively defined by the stopper which directly acts upon the coupling pump impeller, whereby an exact determination of the end position is effected in a simple manner and damage due to a contact between the coupling pump impeller and the coupling turbine wheel can be reliably avoided.

A variable pump for an internal combustion engine is thus provided which has a simple design, is easy to install, and is adapted to be simply controlled. The number of component parts is reduced. In case the actuator fails, moving to an emergency operation position of the coupling pump impeller independent of the actuator At the same time provides an adequate feeding of the fluid to be fed by the impeller.

An exemplary embodiment of the pump according to the present invention is described below on the basis of a coolant centrifugal pump with reference to the drawings.

The coolant pump according to the present invention shown in the drawings comprises a drive wheel 10 which is configured as a belt pulley by which a belt is entrained that is driven by the crankshaft of an internal combustion engine (not shown).

The drive wheel 10 is fastened to a hub 12 which is pressed onto the end of a drive shaft 14. The drive shaft 14 is supported in a housing 18 via a bearing unit 16. For this purpose, a central reception bore 20 is defined in the housing 18, in which bore 20 the bearing unit 16 is fastened and through which the drive shaft 14 extends to the axial end of the housing 18 opposite to the hub 12. The bore 20 is tightly sealed by a mechanical seal 22 towards a pump space 24 in which the coolant to be fed is located and which is also radially delimited by the housing 18. The mechanical seal 22 comprises both an axial sealing face 26 and a radial sealing face 28 which are arranged in the bore 20.

The drive shaft 14 comprises a shoulder 30 at the side of the mechanical seal 22 facing the pump space 24, upon which shoulder 30 a follower 32 rests with a supporting element 34 being interposed. The follower 32 is fixedly connected with, in particular pressed on, the drive shaft 14 in the position in which it presses against the shoulder 30 so that the supporting element 34 is also rotationally coupled with the drive shaft 14 by a force fit. At its outer circumference, the follower 32 comprises a multi-tooth profile with which a corresponding inverse multi-tooth profile 35 of a coupling pump impeller 36 engages which is configured at the inner circumference of the latter and whose axial height is, however, smaller than that of the follower 32 so that a form fit acting in the circumferential direction between the follower 32 and the coupling pump impeller 36 is created. The coupling pump impeller 36 comprises radially extending pump blades 38 between which pump chambers 40 are defined which are radially and axially configured so that they are closed at their side facing the bore 20 and which have a semi-circular shape.

At the side axially facing the bore 20, the coupling pump impeller 36 comprises at its outer circumference a circumferential radial groove 42 which engages with a bolt 44 of an actuator 46. This bolt 44 defines the outlet element of an eccentric 48 which in the present exemplary embodiment is defined by an eccentric arrangement of the bolt 44 at the end of a rotary shaft 50. The rotary shaft 50 is supported in a reception bore 52 in the housing 18 via a sliding bearing 54 and sealed towards the outside via a sealing ring 56. A lever 58 is arranged on the outside at the rotary shaft 50, via which the rotary shaft 50 is connected with an actuator (not shown) so that the rotary shaft 50, and thus the bolt 44, can be moved along a circular path. For axially fixing the rotary shaft 50, the reception bore 52 is closed by a cover 60 through whose inner bore 62 the rotary shaft 50, having a recessed end with a smaller diameter upon which the lever 58 is arranged, extends.

A coil spring 64 also rests in a biased state upon the coupling pump impeller 36 at the closed axial side of the coupling pump impeller 36, the opposite axial end of the coil spring 64 resting upon an annular radial extension 66 of the supporting element 34. The spring force of the coil spring 64 exerts a load upon the coupling pump impeller 36 towards a coupling turbine wheel 68 supported on the drive shaft 14, wherein the axial movement of the coupling pump impeller 36 is limited by a stopper 72 in the form of a ring fastened in a groove 70 of the follower 32, against which the coupling impeller 36 would abut before it would contact the axially opposite coupling turbine wheel 68.

The coupling turbine wheel 68 comprises turbine blades 74 extending towards the coupling pump impeller 36, between which turbine chambers 76 are defined which are merely open towards the coupling pump impeller 36 and are arranged opposite to the coupling pump impeller 36. It is integrally formed with an impeller 78 of the coolant pump configured as a radial pump. The coupling turbine wheel 68 and/or the impeller 78 are fastened to a steel bushing 80 which is arranged in a sliding bearing 82 configured as a collar bushing. Fastening to the drive shaft 14 is effected by means of a screw 84 with a washer 86 into which the end of the drive shaft 14 is screwed so that the washer 86 rests upon the collar of the sliding bushing 82. An axially fixed but rotational arrangement of the impeller 78 is thereby created.

When the drive shaft 14 is driven via the drive wheel 10, the rotation of the drive shaft 14 is transferred via the multi-tooth profile of the follower 32 to the coupling pump impeller 36. The flow produced in the pump chambers 40 acts upon the turbine blades 74 of the coupling turbine wheel 68 so that the coupling turbine wheel 68 rotates together with the coupling pump impeller 36. This results in feeding of the coolant via the co-rotating impeller 78. The rotational speed of the coupling turbine wheel 68 at most equals the rotational speed of the coupling pump impeller 36 and depends on the distance of the coupling pump impeller 36 to the coupling turbine wheel 68. With an increasing distance between the coupling pump impeller 36 and the coupling turbine wheel 68, the force acting upon the coupling turbine wheel 68 decreases so that the coupling turbine wheel 68 is rotated at a lower speed. The rotational speed of the impeller 78 is adjusted via the actuator 46. When the bolt 44 is turned so that it takes up a position at a maximum distance to the impeller 78, the coupling pump impeller 36 is axially displaced, due to the engagement of the bolt 44 and the groove 42, against the spring force of the coil spring 64 on the corresponding multi-tooth profile of the follower 32 towards the mechanical seal 22, whereby the transfer of motion between the coupling pump impeller 36 and the coupling turbine wheel 68 of the coupling is minimized and the rotational speed of the impeller 78 is thus minimized. Upon displacement out of this maximum position of the actuator 46, the coupling pump impeller 36 is accordingly moved towards the coupling turbine wheel 68, whereby the transfer of motion increases and more coolant is fed. A continuous control of the coolant flow via the actuator 46 is accordingly possible.

If the actuator 46 fails due to breakage of the linkage or failure of an electric driving motor, for example, so that no holding force is applied by the bolt 44 onto the coupling pump impeller 36, the coupling pump impeller 36 is displaced by the coil spring 64 on the follower 32 towards the coupling turbine wheel 68 so that an emergency operation position is reached in which maximum feeding via the coolant pump is provided.

This pump is easy to install and is easy to continuously control in the overall desired range of application. Even when the actuator 46 fails, adequate feeding of coolant is still provided. Additional component parts for closing or opening the gap between the coupling turbine wheel 68 and the coupling pump impeller 36 are not required.

It should be appreciated that the scope of protection is not limited to the illustrated embodiment and that various design modifications are possible. For example, the coupling turbine wheel 68 need not be integrally formed with the impeller 78. The type and arrangement of the bearings and seals, housing partitioning, or the type of actuator 46 can also be altered. The follower 32 can be formed integrally with the drive shaft 14 and the coil spring 64 can be configured as a plate spring stack or the like. Reference should be had to the appended claims.

What is claimed is:

1-13. (canceled)

14. A variable pump for an internal combustion engine, the variable pump comprising:
a drive wheel;
a drive shaft configured to be driven via the drive wheel;
a coupling pump impeller comprising pump blades, the coupling pump impeller being arranged to be rotationally fixed on the drive shaft;
a coupling turbine wheel comprising turbine blades arranged axially opposite to the pump blades, the coupling turbine wheel being configured to rotate on the drive shaft;
an impeller which is fixedly connected with the coupling turbine wheel,
wherein,
the coupling pump impeller is arranged so as to be axially displaceable with respect to the coupling turbine wheel.

15. The variable pump as recited in claim 14, wherein the coupling pump impeller is arranged to be rotationally fixed on the drive shaft via a rotationally fixed connection provided by a form fit acting in a circumferential direction.

16. The variable pump as recited in claim 15, further comprising:
a follower arranged at and connected to the drive shaft, the follower being configured to provide the form fit to the coupling pump impeller.

17. The variable pump as recited in claim 16, wherein,
the drive shaft comprises a first multi-tooth profile which is defined at an outer circumference of the drive shaft or the follower comprises the first multi-tooth profile which is defined at an outer circumference of the follower,
the coupling pump impeller comprises a second multi-tooth profile which is defined at an inner circumference of the coupling pump impeller, and
the form fit is provided by the first multi-tooth profile and the second multi-tooth profile.

18. The variable pump as recited in claim 14, further comprising:
an actuator comprising a bolt which is configured to be displaced in an axial direction,
wherein,
the coupling pump impeller comprises an outer circumference at which a circumferential groove is arranged, the circumferential groove being configured to engage with the bolt of the actuator.

19. The variable pump as recited in claim 18, wherein, the actuator further comprises a rotary shaft which serves as an eccentric to which the bolt is eccentrically fastened.

20. The variable pump as recited in claim 19, further comprising:
a housing configured to support the rotary shaft; and
a sealing ring arranged between the rotary shaft and the housing.

21. The variable pump as recited in claim 14, further comprising:
a spring configured to load the coupling pump impeller towards the coupling turbine wheel.

22. The variable pump as recited in claim 21, wherein the spring is a coil spring which is supported on the coupling pump impeller at a side axially opposite to the coupling turbine wheel.

23. The variable pump as recited in claim 21, further comprising:
a supporting element connected with the drive shaft so as to be rotationally fixed,
wherein,
the spring rests upon the supporting element at an axial end of the spring which is opposite to the coupling pump impeller.

24. The variable pump as recited in claim 23, wherein,
the drive shaft comprises a shoulder, and
the supporting element is rotationally fixed by being clamped between the shoulder of the drive shaft and the follower.

25. The variable pump as recited in claim 14, further comprising:
a bearing unit configured to support the drive shaft;
a pump space in which the coupling pump impeller, the coupling turbine wheel, and the impeller are arranged; and
a mechanical seal configured to seal the bearing unit towards the pump space.

26. The variable pump as recited in claim 17, further comprising:
a stopper arranged at the outer circumference of the follower, the stopper being configured to limit an axial movement of the coupling pump impeller towards the coupling turbine wheel.
